(19) United States
(12) Patent Application Publication
(10) Pub. No.: US 2025/0198649 A1
(43) Pub. Date: Jun. 19, 2025

(54) VALVE ASSEMBLY FOR AC CONDENSATE LINE

(71) Applicant: Frank Joseph Hartland, Englewood, FL (US)

(72) Inventor: Frank Joseph Hartland, Englewood, FL (US)

(21) Appl. No.: 18/746,284

(22) Filed: Jun. 18, 2024

Related U.S. Application Data
(60) Provisional application No. 63/610,003, filed on Dec. 14, 2023.

(51) Int. Cl. F24F 13/22

(52) U.S. Cl. CPC F24F 13/222; F24F 2221/225

(57) ABSTRACT

The present disclosure discloses a valve assembly. The valve assembly includes a tee shaped structure configured to receive water from a garden hose and an air conditioner condensate line, and configured to output the water to a drain line. The valve assembly further includes one or more valves disposed on the tee shaped structure. The valves are configured to regulate a flow of water to the drain line from the garden hose and/or the air conditioner condensate line.

### CROSS-REFERENCE TO RELATED APPLICATION

This application claims the benefit of priority of U.S. provisional application No. 63/610,003, filed Dec. 14, 2023, the contents of which are herein incorporated by reference.

### BACKGROUND OF THE INVENTION

The present invention relates generally to a valve assembly for an air conditioning condensate line, and more particularly to a valve assembly that allows the user to flush their air conditioning condensate line with a garden hose without flooding the air handler.

Over time, air conditioner condensate lines fill with mold growth, which ultimately leads to the drain line backing up with water. This stops the air conditioner from working properly and causes frustration and discomfort for the user until the issue is resolved. Often, the blockage is halfway down the line and is extremely difficult to unclog without specialty tools.

Therefore, a system is required that enables a user to conveniently and easily unclog the air conditioner condensate line.

### SUMMARY OF THE INVENTION

The following presents a simplified summary of the present disclosure in a simplified form as a prelude to the more detailed description that is presented herein.

In accordance with preferred embodiments of the present invention, there is provided a valve assembly. The valve assembly includes a tee shaped structure configured to receive water from a garden hose and an air conditioner condensate line configured to output the water to a drain line. The valve assembly further includes one or more valves disposed on the tee shaped structure. The valves are configured to regulate the flow of water to the drain line from the garden hose and/or the air conditioner condensate line.

The valve assembly, as disclosed in the present disclosure, attaches to the condensate line, and allows the user to attach a garden hose onto the condensate line. Once turned on, the hose flushes out all blockages and debris quickly and without the need for specialty tools or technicians.

These and other features, aspects, and advantages of the present invention will become better understood with reference to the following description.

### BRIEF DESCRIPTION OF THE DRAWINGS

FIG. 1 is a perspective view of a valve assembly for an AC condensate line in accordance with a preferred embodiment of the present invention;

FIG. 2 is an exploded view of the valve assembly of FIG. 1;

FIG. 3 is a cross-sectional view of the valve assembly taken along line 3-3 of FIG. 1; and

FIG. 4 is a cross-sectional view of the valve assembly taken along line 3-3 of FIG. 1 showing motion of the ball valve and the garden hose valve.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a valve assembly for an AC condensate line, and more particularly to a valve assembly that allows the user to flush their air conditioning condensate line with a garden hose without flooding the air handler.

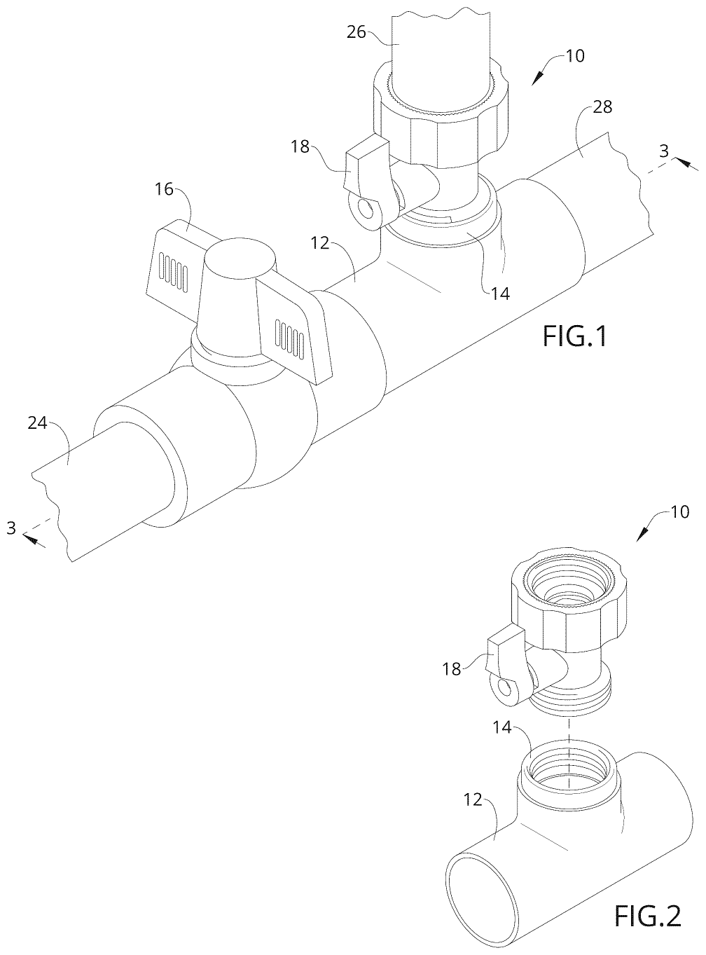

FIG. 1 depicts a perspective view of a valve assembly 10 (or tee assembly) in accordance with preferred embodiments of the invention. FIG. 1 will be described in conjunction with FIGS. 2, 3 and 4. The valve assembly 10 (or assembly 10) includes a tee 12, an insert 14, and a garden hose valve 18. The assembly 10 may be attached with an air handler drain line 24 via a coupling 20. The coupling 20 may include a ball valve 16. The assembly 10 may be further attached with a garden hose line 26 and a drain exit line 28.

The components required to make the assembly 10 include a brass ball valve 18, with male to female threads (garden hose thread, seen in FIG. 2 by way of example), Teflon thread sealing tape, custom PVC tee 12 with slip fittings on 2 sides and garden hose thread metal insert 14 at the top section, 0.5 to 1.5 inch piece of schedule 40 PVC pipe, and 0.75 inch schedule 40 slip ball valve 18.

To make the assembly 10, the Teflon tape is applied to the male end of the brass valve 18 and threaded into the custom PVC tee 12. Then the piece of 0.5 to 1.5 inch piece of schedule 40 PVC pipe is attached to both the 0.75 inch schedule 40 slip ball valve 18 and the custom PVC tee.

During installation of the assembly 10, an approximately six inch piece is cut out and removed from the user's existing AC condensate line 24. This cut is made as close as possible to the air handler (not shown). Using PVC glue, the assembly 10 is attached to the condensate line 24 where the pipe was removed and therefore becomes part of the AC drain line 28. The assembly 10 must be installed with a PVC ball valve 16 on the side of the condensate line closest to the air handler.

Once installed, the user flushes their AC drain line 28 as follows: Firstly, the user turns off the AC system. The user then attaches the garden hose (turned off) to brass valve 18 of assembly 10. The user then turns the PVC ball valve 16 to its closed position. The user then turns the brass valve 18 to its “Open” position. The user then turns the water on to garden hose 26. The user then allows blockage to unclog until clear water runs smoothly out of condensate line 28. Thereafter, the user turns off the garden hose 26. The user then removes the garden hose 26 from assembly 10. The user then turns the brass valve 18 to the “Closed” position. The user then turns the PVC ball valve 16 to the “Open” position and turns the AC system back on.

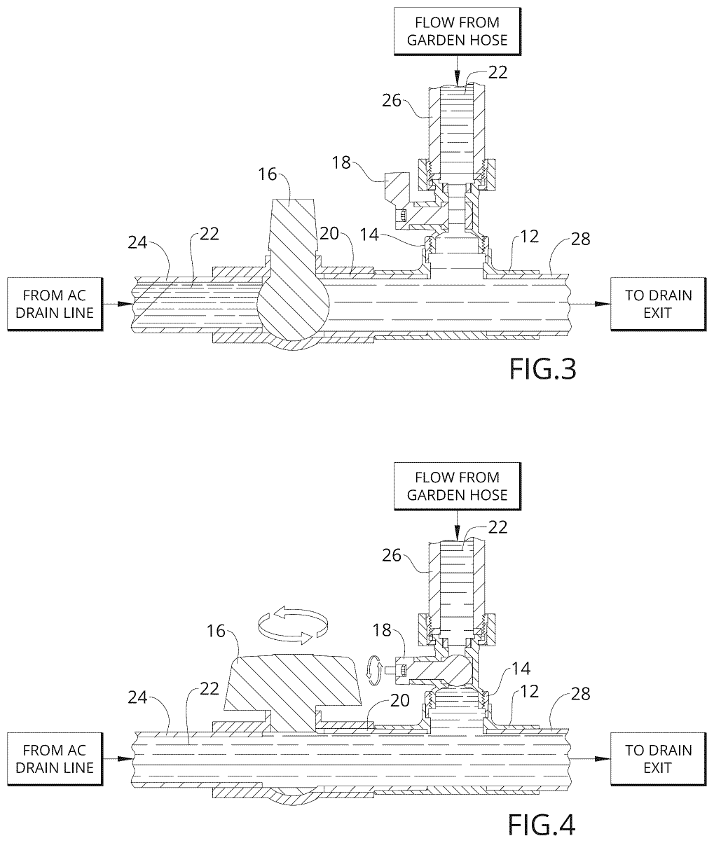

As shown in FIG. 3, when the ball valve 16 is closed and the garden hose valve 18 is open, water 22 flows from the garden hose 26 towards the drain exit line 28, thereby unclogging the AC condensate line. In this arrangement, the water 22 from the coupling 20 does not flow towards the drain exit line 28. On the other hand, as shown in FIG. 4, when the ball valve 16 is open and the garden hose valve 18 is closed, the water 22 flows from the coupling 20 towards the drain exit line 28 (and not from the garden hose towards the drain exit line 28).

In some aspects, the brass valve 18 may be replaced with a fixed garden hose fitting and a cap, rather than a valve. The brass valve 18 may further be replaced with a plastic version. The custom tee 12 may be replaced with an off-the-shelf version. However, the function remains the same. There must be a valve to stop water flowing back to the air handler, and a hose connection in front of it to allow the water to flow through the line under pressure.

The assembly 10 could also be used in irrigation systems to unclog sediment filled pipes. The assembly 10 could also be used to put bleach, vinegar or other chemicals into the condensate line, through the brass fitting.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

It should be understood, of course, that the foregoing relates to exemplary embodiments of the invention and that modifications may be made without departing from the spirit and scope of the invention as set forth in the following claims.

What is claimed is:

1. A valve assembly for an AC condensate line, the assembly comprising:
garden hose connector having a female end for accepting a garden hose, a male end for attaching to a PVC tee connector, and a valve between the female end and the male end;
the PVC tee connector having a first opening comprising a female threaded portion for accepting the male end of the garden hose valve, a second opening designed to be connected an inlet from an AC drain line, and a third opening designed to be connected to an AC drain line exit.

2. The valve assembly of claim 1, wherein the female threaded portion of the PVC tee connector comprises a threaded coupling attached to the PVC tee.

3. The valve assembly of claim 1, wherein the valve between the female end and the male end of the garden hose connector is a brass valve.

4. The valve assembly of claim 1, further comprising a ball valve assembly having a first opening designed to be connected to the second opening of the PVC tee connector, a second opening designed to be connected to an AC drain line inlet, and a ball valve between the first and second openings of the ball valve.

5. A valve assembly comprising:
a tee shaped structure configured to receive water from a garden hose and an air conditioner condensate line, and configured to output the water to a drain line; and
one or more valves disposed on the tee shaped structure, wherein the one or more valves are configured to regulate a flow of water to the drain line from at least one of the garden hose and the air conditioner condensate line.

6. The valve assembly of claim 5, wherein the one or more valves comprise a garden hose valve and a PVC ball valve.
